(19) United States
(12) Patent Application Publication
(10) Pub. No.: US 2015/0178404 A1
(43) Pub. Date: Jun. 25, 2015

(54) FAST RENDERING OF VISUALIZATION

(71) Applicant: Urban Engines, Inc., Los Altos, CA (US)

(72) Inventor: Deepak Merugu, Sunnyvale, CA (US)

(21) Appl. No.: 14/578,267

(22) Filed: Dec. 19, 2014

Related U.S. Application Data
(60) Provisional application No. 61/919,455, filed on Dec. 20, 2013.
(60) Provisional application No. 61/975,664, filed on Apr. 4, 2014.
(60) Provisional application No. 61/996,681, filed on May 14, 2014.

(51) Int. Cl. G06F 17/30; H04L 29/06

(52) U.S. Cl. CPC G06F 17/30905; G06F 17/30371; H04L 67/42

(57) ABSTRACT

A system for fast rendering of visualization includes a server computer and a client device. The client device determines a set of data required for rendering a visualization on a client device based on a user input and transmits a request for the set of data to the server computer. The client device receives one or more terse tables corresponding to the set of data, generates the set of data by combining the received one or more terse tables, and rendering a visualization on the client device based on the set of data.

### CROSS-REFERENCE TO RELATED APPLICATION(S)

This application claims priority under 35 U.S.C. §119(e) to U.S. Provisional Patent Application Ser. No. 61/919,455, “Understanding and Managing Transportation System Operations and Usage,” filed Dec. 20, 2013, which is incorporated herein by reference in its entirety, to U.S. Provisional Patent Application Ser. No. 61/975,664, “Fast Rendering of Visualization”, filed Apr. 4, 2014, and to U.S. Provisional Patent Application Ser. No. 61/996,681, “Transportation System Reconstruction,” filed May 14, 2014, which is incorporated herein by reference in its entirety.

### BACKGROUND

1. Field of Art

The disclosure generally relates to the field of server-client data communication, and specifically to the fast rendering of visualizations under a server-client architecture.

2. Description of the Related Art

The industry currently follows a traditional server-client architecture for sending data and enabling visualizations on the client. This traditional architecture and division of work between server and client might have significant disadvantages. For example, in the traditional server-client architecture, a huge amount of data processing work is to be done on the server, causing the server to be overloaded.

In addition, to enable rendering visualizations on the client, the server and the client may be required to communicate a large number of processing results with each other. Therefore, the communication of the large number of processing results may cause intolerable delay of the visualization rendering.

### BRIEF DESCRIPTION OF THE DRAWINGS

FIG. 1 is a high-level block diagram of an example computing environment for enabling fast rendering of visualizations according to one embodiment.

FIG. 2 is a block diagram illustrating components of an example machine able to read instructions from a machine-readable medium and execute them in a processor (or controller) for acting as a client device and/or server according to one embodiment.

FIG. 3 is a flowchart illustrating an example method for providing terse tables according to one embodiment.

FIG. 4 is a flowchart illustrating an example method for implementing an application, e.g., rendering a visualization on the client device according to one embodiment.

FIGS. 5-11 are example graphical representations for user interfaces displaying different visualizations.

### DETAILED DESCRIPTION

The disclosed embodiments have advantages and features which will be more readily apparent from the detailed description, and the accompanying figures (or drawings).

The FIGS. and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

To overcome the deficiency of the traditional server-client data communication architecture, a system (and computer-implemented method) is configured to implement an application on a client device. In one example configuration, the system determines a set of data required for implementing an application on a client device based on a user input. The system sends a request for the set of data to a server and receives one or more terse tables corresponding to the set of data. The system combines the one or more terse tables to generate the set of data. The system then implements the application on the client device based on the set of data.

The system provides numerous advantages over the traditional model. First, the system enables huge reduction in size of data sent by the server, for example, in applications where processed data is highly dependent on certain common data. Second, the system allows a faster communication between the server and the client and thus reduces communication latency. This is particularly helpful for interactive and real-time visualizations. Third, the system reduces load on the server side and leads to a simple and lean application programming interface (API) on the server side. Fourth, the system enables fast and real-time interaction with huge datasets by using a simple data chunking logic and handling all the processing on the client side. Fifth, local caching and processing makes the system also suitable for offline use. Sixth, the system uses localized processing logic and allows a faster development.

### Example Computing Environment

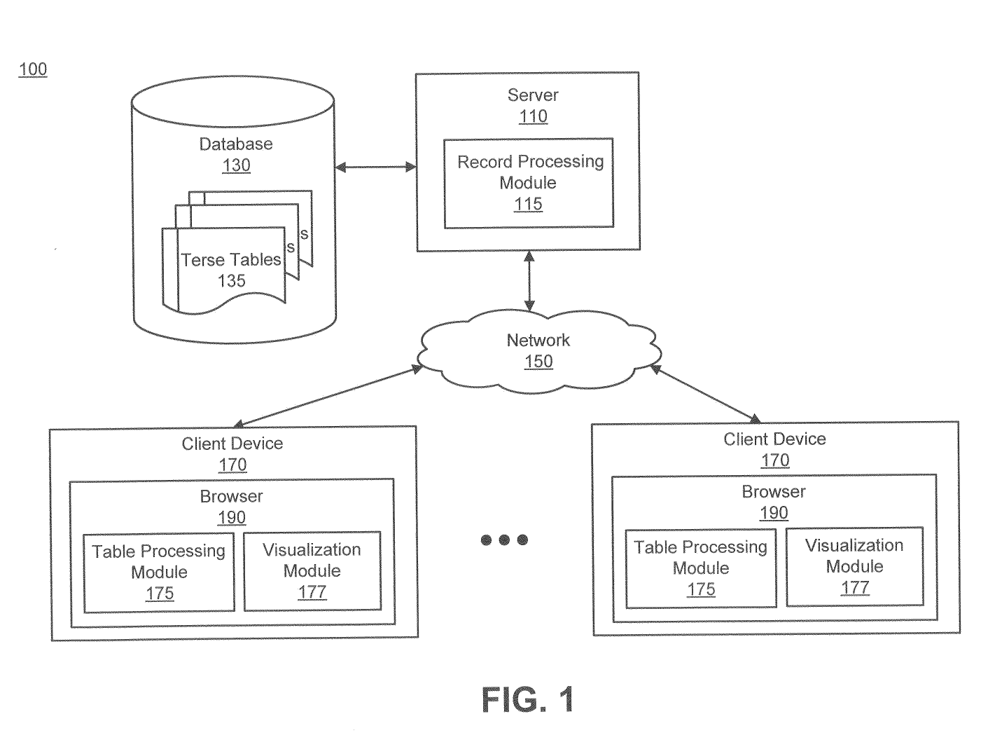

FIG. 1 shows a computing environment 100 for enabling fast rendering of visualizations according to one embodiment. The computing environment 100 includes a server 110, a plurality of client devices 170 and a database 130 connected by a network 150. Only one server 110, two client devices 170 and a database 130 are shown in FIG. 1 in order to simplify and clarify the description. Alternate or additional embodiments of the computing environment 100 can have multiple servers 110, client devices 170 and databases 130 connected to the network 150. Likewise, the functions performed by the various entities of FIG. 1 may differ in different embodiments.

The server 110 includes a record processing module 115. The database 130 includes one or more terse tables 135. The client devices 170 include a browser 190, within which there is a table processing module 175 and a visualization module 177.

The server 110 generates and stores terse tables that are used for rendering visualizations on the client devices 170 for users. In one embodiment, the server 110 retrieves raw data from a variety of resources and processes the raw data to generate terse tables. In addition, the server 110 provides, via the network 150, the terse tables to the client device 170 in response to receiving requests from the client device 170. In one embodiment, the server 110 includes the record processing module 115, but other embodiments of the map server 110 include different and/or additional components. In addition, the functions may be distributed among the components in a different manner than described herein.

The record processing module 115 processes the raw data and generates terse tables based on processed raw data. In one embodiment, the record processing module 115 collects raw data about public transportations from a variety of resources. The raw data can include records collected from transportation systems including bus lines, trains, subway lines, etc. For example, each transportation station such as a subway station may be equipped with a sensor unit allowing commuters to swipe-in and swipe-out (e.g., entry and exit into the subway). In another example, each transportation vehicle such as a subway, a bus or a train may be equipped with a similar sensor unit to detect commuters' entry and exit. In either case, records of commuters' swiping-in and swiping-out the transportation vehicle can be collected from the sensor unit.

In another embodiment, the raw data may also include metadata of the public transportations such as transmit routes of buses, trains, subway lines, etc. In another embodiment, the record processing module 115 collects transportation system center data such as speed measurements and global positioning system (GPS) locations for the transportation vehicles, station information, station occupancy information, traffic delay information, etc. In yet another embodiment, the record processing module 115 also collects raw data from mobile apps used by commuters. For example, the record processing module 115 collects individual GPS logs of commuters.

In one embodiment, the record processing module 115 analyzes the collected raw data to generate processed data. For example, the processed data may describe movements of the individual transportation vehicles (e.g., buses, trains, subways). In another example, the processed data may also describe an estimated waiting time for each transportation line at each stop or station. Specifically, the record processing module 115 analyzes the collected records and calculates a waiting time for each line at each stop or station based on transportation system center data and/or sensor data such as swipe-in and swipe-out data. For example, the record processing module 115 can use a speed measurement and a geo-location of a bus to estimate the waiting time at one stop of the bus line. The record processing module 115 can also use traffic delay information to adjust the waiting time dynamically. In addition, the record processing module 115 can calculate how many people are currently in the bus using the swipe-in and swipe-out data, determine how many people are waiting at the next stop of the bus using the station occupancy information, and then estimate whether all the waiting people can get in the bus at this next stop. The record processing module 115 then adjusts the waiting time based on the estimation. In other examples, the processed data may also describe occupancy of each transportation vehicle such as how many people are in each bus, train or subway. Additional details with respect to the operations of the record processing module 115 can be found in the co-pending application entitled, “Transportation System Reconstruction,” filed on the same day as this application, by Morteza Ibrahimi, Damon Jude Wischik, Christopher David Pluntke, Balaji Satyanarayana Prabhakat, and Deepak Merugu. This co-pending application is incorporated herein by reference in its entirety.

In one embodiment, the record processing module 115 extracts information from the processed data and stores the extracted information in terse tables. A terse table is a table that can include data describing elements or characters used to generate graphical user interfaces (GUIs) for rendering visualizations to users. For example, terse tables store pieces of data defining locations of elements in the GUIs and styles of the elements such as color, size, shape, etc. In one embodiment, the terse tables include multiple entries each corresponding to such a piece of data. In one embodiment, the terse tables store data generated based upon records within a predetermined length of time such as three months. The record processing module 115 stores the terse tables in the database 130. In one embodiment, the terse tables are tables with a normalized data schema so as to minimize redundant data and improve storage efficiency.

In one embodiment, the record processing module 115 provides terse tables to the client devices 170. For example, the record processing module 115 receives a request from a client device 170 for terse tables, and fetches requested terse tables based on the request from the database 130 to provide the requested terse tables to the client device 170 without any processing of the requested terse tables. According to some embodiments, only a portion of a terse table such as a portion including one or more entries is requested, and the record processing module 115 fetches the requested entries and sends to the client device 170. For example, the client device 170 has received terse tables for rendering a GUI displaying dynamic operation of a bus system. The terse tables include data defining routes of buses, locations of the buses at each timestamp, stop information (e.g., stop location, stop name), and occupancy information for each bus. Therefore, when the client device 170 requests terse tables to update the GUI after a certain interval such as five minutes, the client device 170 can request only entries related to data defining updated locations for the buses and updated occupancy information of the buses, without requesting terse tables including data that defines the routes of the buses and stop information.

A client device 170 is an electronic device used by a user to perform functions such as querying transportation information, consuming digital content, executing software applications, browsing websites hosted by web servers on the network 150, downloading files, and interacting with the server 110. In one embodiment, the client device 170 can also have templates defined and locally stored for applications to render visualizations to users. Alternatively, the client device 170 can select data and pull down the templates from the server 110. Even further, the server 110 includes definable templates in the terse tables for the pull by the client device 170 rather than real-time processing of raw data.

The client device 170 may be a dedicated e-Reader, a smartphone, or a tablet, laptop, notebook, or desktop computer. The client device 170 includes and/or interfaces with a display device on which the user may view the visualizations such as graphical user interfaces (GUIs) showing transportation information. In addition, the client device 170 provides a user interface (UI), such as physical and/or on-screen buttons, with which the user may interact with the client device 170 to perform functions such as tapping on elements of transportation maps (e.g., a bus stop label, a train station label, etc.), inputting a stop or station name, selecting a bus or subway line, zooming in and/or out the transportation maps, and any other possible interactions.

In one embodiment, the client device 170 includes the table processing module 175 and the visualization module 177, but other embodiments of the map server 110 include different and/or additional components. In addition, the functions may be distributed among the components in a different manner than described herein.

The table processing module 175 requests and combines terse tables to generate application data for implementing applications (e.g., visualization data for rendering visualizations) on the client device 170. The table processing module 175 can include optimized source code in Javascript. In one embodiment, the table processing module 175 determines a set of data for implementing an application such as rendering a visualization on the client device 170. For example, to render a map showing conditions of a number of bus lines, the table processing module 175 determines that data defining visualization for routes of the bus lines is needed. The table processing module 175 determines that data defining visualization for occupancy of each bus and a waiting time for each stop is also needed. The data defining visualization for each character of the map mentioned above (e.g., the routes, the occupancy and the waiting times) may describe color, size, shape, location on the map, etc., of each character. For example, the data specifies the waiting time as a bar with different lengths to indicate different waiting times. Specifically, the length of the bar can be in proportion to the length of the waiting time. In another example, the data specifies different routes of the bus lines as different colors.

In one embodiment, the table processing module 175 determines a subset of data for implementing an application such as rendering a visualization on the client device 170. For example, the table processing module 175 determines the minimum set of data necessary for rendering a visualization, such as a GUI displaying occupancy of a number of bus lines. Assume that based on previous requests, the table processing module 175 has received terse tables including data for rendering a map displaying occupancy of the bus lines as of 10 minutes ago. The table processing module 175 stores the received terse table locally in the client device 170. Therefore, the table processing module 175 determines what is updated during the 10 minutes and then determines the minimum necessary data for rendering the updated occupancy information. In one embodiment, the table processing module 175 periodically deletes outdated data such as data of three months or older.

In one embodiment, the table processing module 175 receives the requested terse tables or a portion of the terse table from the server 110 and combines the terse tables or the portion of terse table with existing terse tables on the client device 170 to generate data for implementing applications on the client device 170. For example, the table processing module 175 combines the portion of terse table with the entries previously stored on the client device 170 to generate data for rendering visualization. The table processing module 175 may combine tables or table entries based on their common identification information. For example, a first entry describes station occupancy and includes variables of a station identification (ID), time and occupancy; a second entry describes station information and includes variables of a station ID, a station name and time. The table processing module 175 can combine the two entries based on the common variable they have, i.e., the station ID.

The visualization module 177 renders visualizations based on the data generated by the table processing module 175. For example, the visualization module 177 renders a GUI displaying occupancy information for a number of subway lines using the combined data from the terse tables. In one embodiment, the visualization module 177 uses terse and declarative grammar for general visualizations based on Grammar of graphics. In addition, the visualization module 177 uses extended grammar of graphics to support interactions, animations and controls. The visualization module 177 is optimized for modern browsers using scalable vector graphics (SVG) and Canvas. Similar to the table processing module 175, the visualization module 177 can include optimized source code in Javascript.

For one example embodiment, assume that three terse tables have been stored in the database 130. The first one is a bus location table: Bus Location (bus id, route id, stop id, timestamp, occupancy) and has 100,000 records, each of size five units. The second one is a bus route table: BusRoute (route id, route name, route code) and has 100 records, each of size three units. The third one is a bus stop table: BusStop (stop id, stop name, stop location (latitude, longitude)) and has 1000 records, each of size four units. In order to generate a visualization such as a GUI that shows all the buses along with information of the buses on a map over a day, records related to route name, route code, stop name, stop location (latitude, longitude) are needed. Therefore, it requires a multi-table join of the bus location table, the bus route table and the bus stop table, leading to 100,000 records, each of size 10 units. The present system 100 avoids sending 1000,000 units (i.e., 100,000 x10) of data from the server 110 to the client device 170 when rendering the GUI on the client device 170, which may cause a delay due to the huge amount of the data to be sent. Instead, the server 110 sends only the three terse tables to the client device 170, involving a total data size of 504,300 units (i.e., 100,000*5+100*3+1000*4). Accordingly, by sending unprocessed terse tables from the server 110 to the client device 170 and letting the client device 170 process the terse tables such as combing the terse tables, the system 100 saves around 50% of data traffic. Furthermore, many different data records that are required often depend on the same terse tables and therefore an even higher saving is possible.

The network 150 enables communications among the store server 110, client devices 170 and the external data source 160 and can comprise the Internet. In one embodiment, the network 150 uses standard communications technologies and/or protocols. In another embodiment, the entities can use custom and/or dedicated data communications technologies instead of, or in addition to, the ones described above.

### Computing Machine Architecture

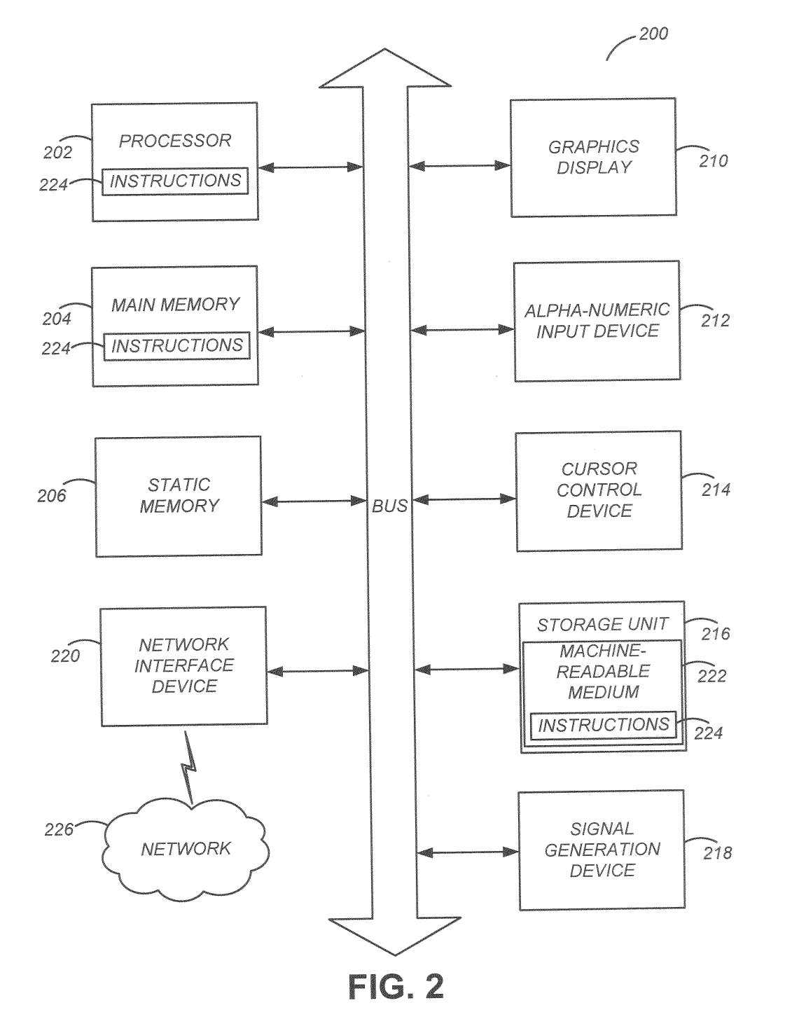

Referring now to FIG. 2, it is a block diagram illustrating components of an example machine able to read instructions (e.g., software or program code) from a machine-readable medium and execute them in a processor (or controller) for acting as a client device 170 and/or map server 110 according to one embodiment. Specifically, FIG. 2 shows a diagrammatic representation of a machine in the example form of a computer system 200 within which instructions 224 (e.g., software or program code) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 224 (sequential or otherwise) that specify actions to be taken by that machine. Further, while only a single machine is illustrated, the term “machine” shall also be taken to include any collection of machines that individually or jointly execute instructions 224 to perform any one or more of the methodologies discussed herein.

The example computer system 200 includes one or more processors (generally processor 202) (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 204, and a static memory 206, which are configured to communicate with each other via a bus 208. The computer system 200 may further include graphics display unit 210 (e.g., a plasma display panel (PDP), a liquid crystal display (LCD), a projector, or a cathode ray tube (CRT)). The computer system 200 may also include alphanumeric input device 212 (e.g., a keyboard), a cursor control device 214 (e.g., a mouse, a trackball, a joystick, a motion sensor, or other pointing instrument), a storage unit 216, a signal generation device 218 (e.g., a speaker), and a network interface device 220, which also are configured to communicate via the bus 208.

The storage unit 216 includes a machine-readable medium 222 on which is stored instructions 224 embodying any one or more of the methodologies or functions described herein. The instructions 224 may also reside, completely or at least partially, within the main memory 204 or within the processor 202 (e.g., within a processor's cache memory) during execution thereof by the computer system 200, the main memory 204 and the processor 202 also constituting machine-readable media. The instructions 224 (e.g., software) may be transmitted or received over a network 226 via the network interface device 220.

While machine-readable medium 222 is shown in an example embodiment to be a single medium, the term “machine-readable medium” should be taken to include a single medium or multiple media (e.g., a centralized or distributed database, or associated caches and servers) able to store instructions (e.g., instructions 224). The term “machine-readable medium” shall also be taken to include any medium that is capable of storing instructions (e.g., instructions 224) for execution by the machine and that cause the machine to perform any one or more of the methodologies disclosed herein. The term “machine-readable medium” includes, but not be limited to, data repositories in the form of solid-state memories, optical media, and magnetic media.

### Example Methods

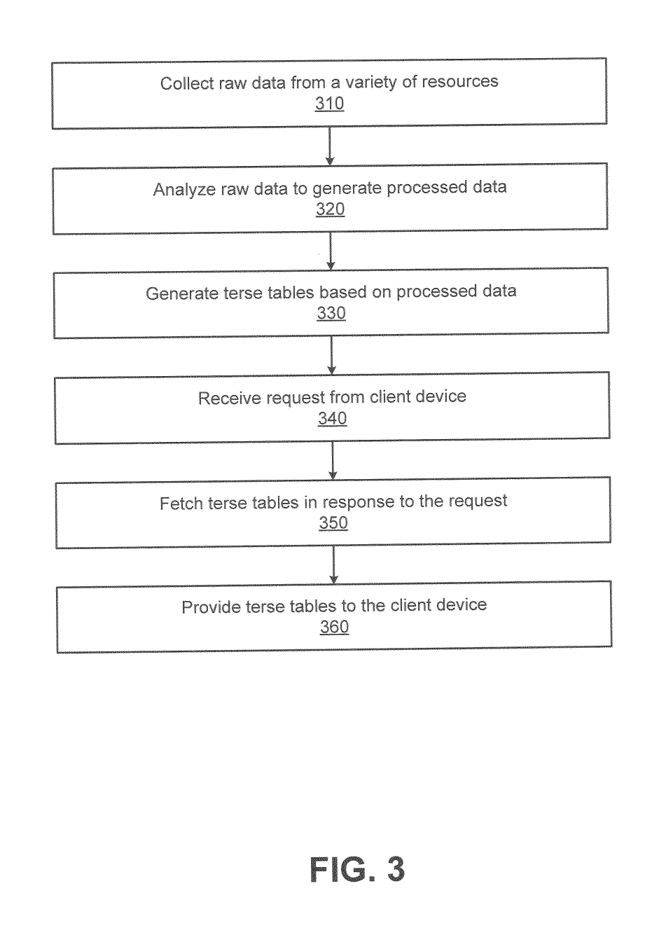

Turning now to FIG. 3, it is a flowchart illustrating an example method for providing terse tables according to one embodiment. FIG. 3 attributes the steps of the method to the record processing module 115 of the server 110. However, some or all of the steps may be performed by other entities. In addition, some embodiments may perform the steps in parallel, perform the steps in different orders, or perform different steps. Also, it is noted that in one example embodiment the steps and/or modules may be embodied as instructions, e.g., 224, that may be executed by the processor 202 described with respect to FIG. 2.

Initially, the record processing module 115 collects 310 raw data from a variety of resources. As described previously with regard to FIG. 1, the raw data can include records collected from public transportation systems such as bus line system, train system, subway line system, etc. The record processing module 115 analyzes 320 the collected raw data to generate processed data. For example, the record processing module 115 analyzes the records to estimate movements, waiting times and occupancy for each bus, train or subway line.

At step 330, the record processing module 115 generates terse tables based on the processed data. As described previously with regard to FIG. 1, the record processing module 115 extracts information based on the processed data and stores the extracted information in terse tables in the database 130. For example, the record processing module 175 generates a terse table for bus locations and the terse table includes five columns such as bus ID, route ID, stop ID, timestamp and occupancy. The terse table may include 100,000 entries, each of size five units.

At step 340, the record processing module 115 receives a request from the client device 170. For example, the client device 170 requests terse tables having route name, route code, stop name and stop location as entries. At step 350, the record processing module 115 fetches the terse tables in response to the request. At step 360, the record processing module 115 provides the terse tables to the client device 170. For example, the record processing module 115 sends the terse tables to the client device 170 without any processing of the terse tables such as combining of the terse tables.

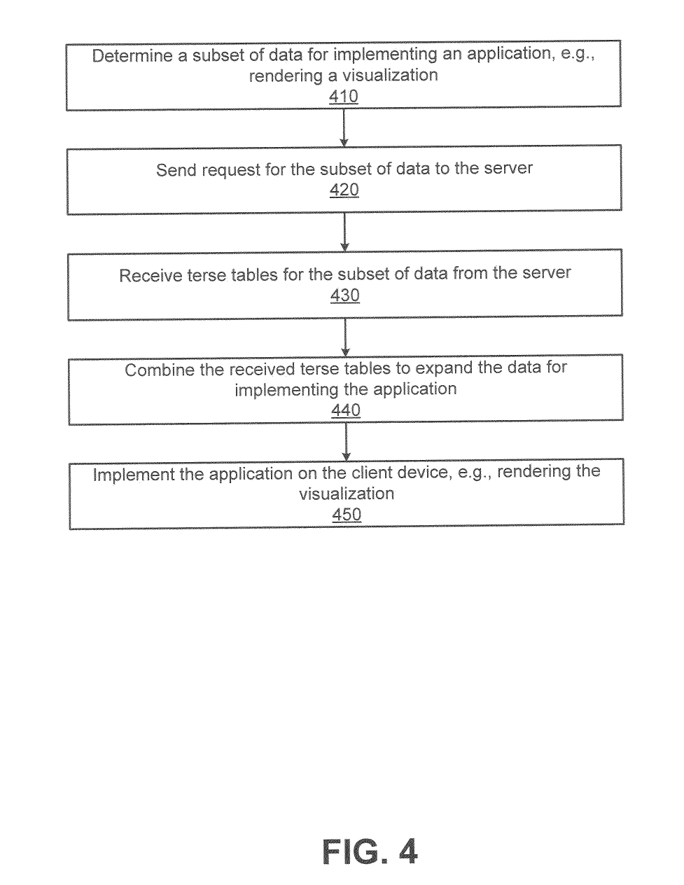

FIG. 4 is a flowchart illustrating an example method for implementing an application, e.g., rendering a visualization on the client device 170 according to one embodiment. FIG. 4 attributes the steps of the method to the table processing module 175 and/or the visualization module 177 of the client device 170. However, some or all of the steps may be performed by other entities. In addition, some embodiments may perform the steps in parallel, perform the steps in different orders, or perform different steps.

Initially, the table processing module 175 determines 410 a subset of data for implementing an application, e.g., rendering a visualization. As described previously with regard to FIG. 1, to render a GUI showing all buses on a map over a day, the table processing module 175 determines that information of route names, route codes, stop names and stop locations is needed. In one embodiment, the table processing module 175 may detect that data describing route names and route codes has been requested and stored locally in the client device 170 due to previous actions. Therefore, the table processing module 175 determines that only data describing stop names and stop locations are needed. The table processing module 175 sends 420 a request for the subset of data to the server 110. For example, the table processing module 175 sends a request to the server 110 for the data describing the stop names and stop locations.

At step 430, the table processing module 175 receives terse tables for the subset of data from the server 110. For example, the table processing module 175 receives a terse table describing bus stops and the terse table has data of stop IDs, stop names and locations. At step 440, the table processing module 175 combines the received terse tables to expand the data for implementing the application. For example, the table processing module 175 combines the terse table describing bus stops with previously stored data describing route names and route codes to expand the data necessary for rendering the GUI showing all the buses on a map over a day.

At step 450, the visualization module 177 implements the application on the client device 170. For example, the visualization module 177 renders the GUI showing all the buses on a map over a day on the client device 170 based upon the data.

### Example User Interfaces

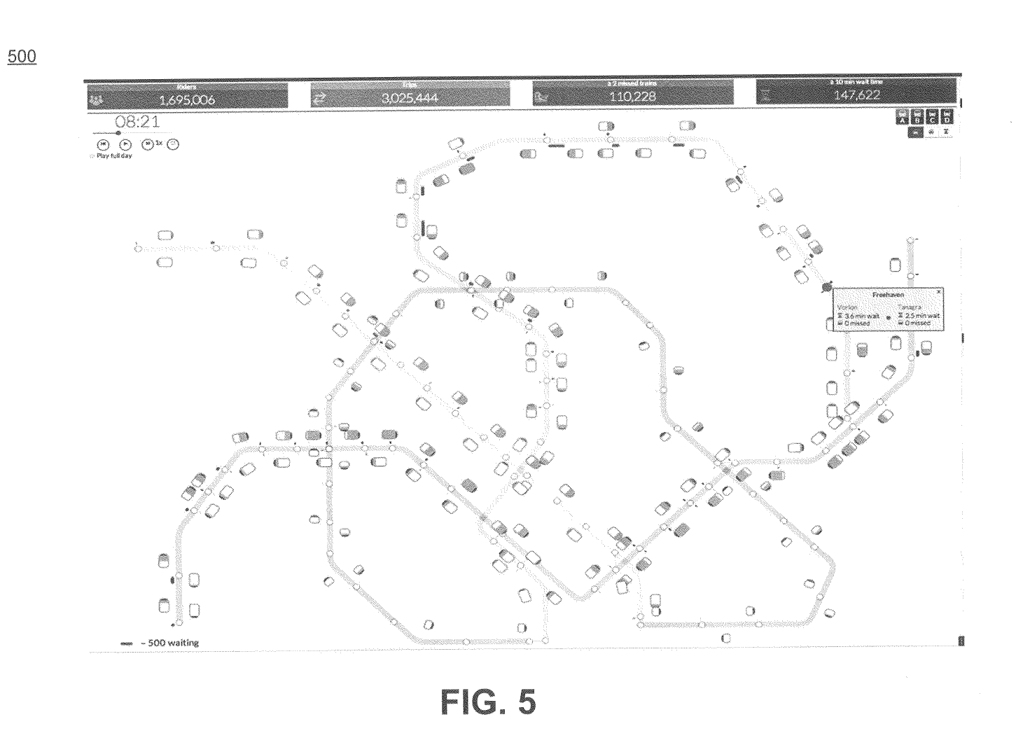

Referring now to FIGS. 5-11, illustrated are example graphical representations for graphical user interfaces (GUIs) displaying different visualizations. For example, the GUIs are generated by the visualization module 177 of the client device 170. FIG. 5 illustrates a GUI 500 showing an overall traffic condition for a train system. For example, the train system includes four train lines. The GUI 500 of FIG. 5 displays the routes for the four train lines. The GUI 500 also shows, at each time, locations of the trains for each line, occupancy condition for each train, the number of waiting riders at each station and an estimated waiting time at each station. For example, the record processing module 115 on the server 110 gathers raw data including records taken by the public transportation systems and generates processed data based on the raw data. The record processing module 115 then extracts information from the processed data to generate terse tables including elements or characters for rendering the GUIs, such as the GUI 500. When a user of a client device 170 requests a GUI such as the GUI 500, the client device 170 pulls necessary one or more terse tables from the server 110 and combines the terse tables to render the GUI 500 to the user.

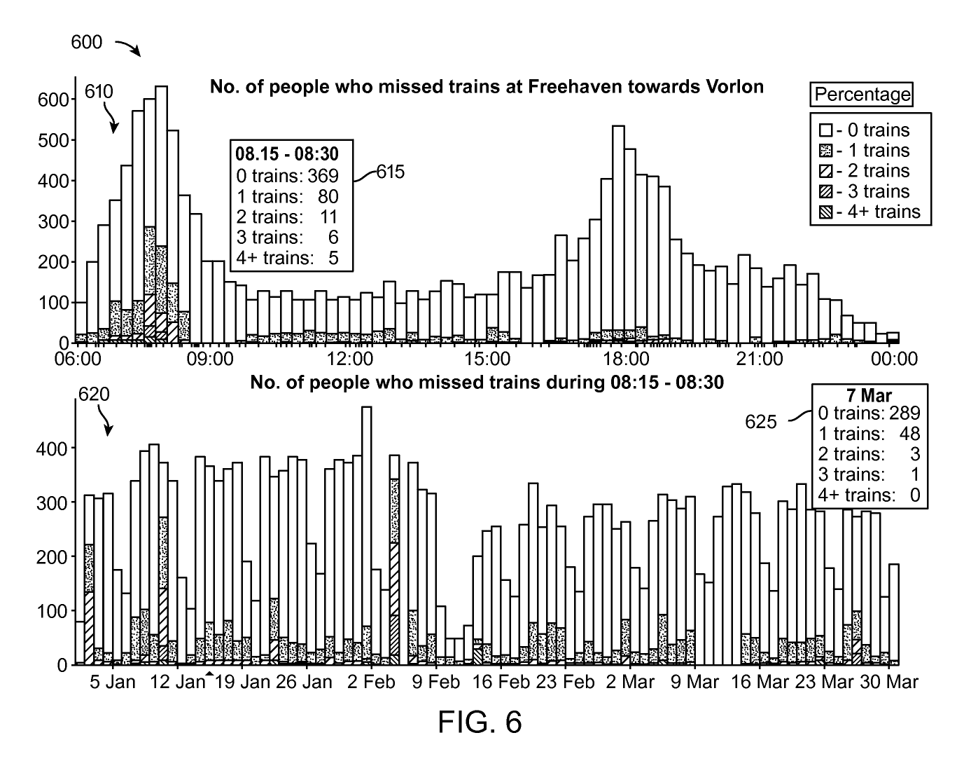

FIG. 6 illustrates charts 610 and 620 that display the numbers of people who missed trains. For example, the chart 610 shows the numbers of people who missed zero train, one train, two trains, three trains and four or more trains from 6:00 AM to 00:00 AM during a day. To display an exemplary statistics, the chart 610 also includes a list 615 describing the numbers of people who missed zero train, one train, two trains, three trains and four or more trains during 8:15 AM-8:30 AM. For example, the numbers of people who missed trains over a day can be calculated by the record processing module 175 based on the raw data and be stored in the terse tables. The client device 170 can pull the terse tables and combine the terse tables to render visualizations such as the chart 610. The chart 620 shows the numbers of people who missed zero train, one train, two trains, three trains and four or more trains during 8:15 AM-8:30 AM from January 5 to March 25. The chart 620 also includes a list 625 describing the numbers of people who missed zero train, one train, two trains, three trains and four or more trains during 8:15 AM-8:30 AM on March 7. Similarly, the numbers of people who missed trains from January 5 to March 25 can be calculated by the record processing module 175 based on the raw data and be stored in the terse tables. The client device 170 can pull the terse tables and combine the terse tables to render visualizations such as the chart 620.

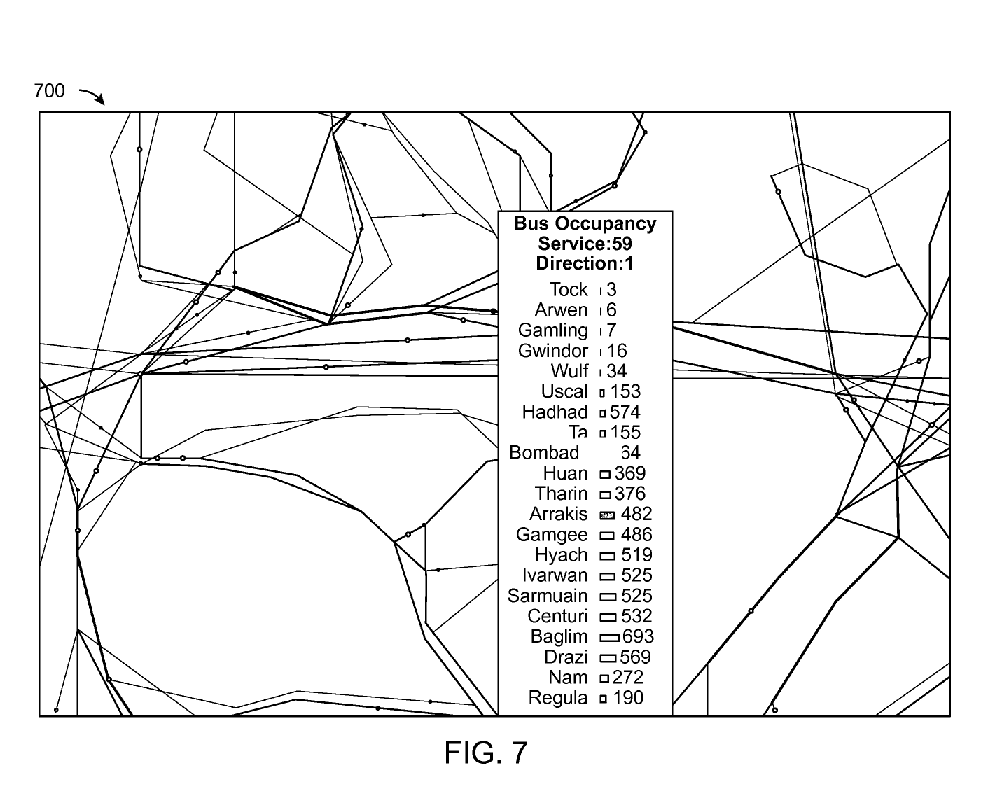

FIG. 7 illustrates a visualization 700 showing routes of bus lines and locations of buses. The visualization 700 also displays occupancy of each bus. Data describing routes of bus lines, locations of buses and occupancy of each bus is extracted and saved in the terse tables in the database 130 by the record processing module 115. The client device 170 requests and receives the terse tables for rendering the visualization 700.

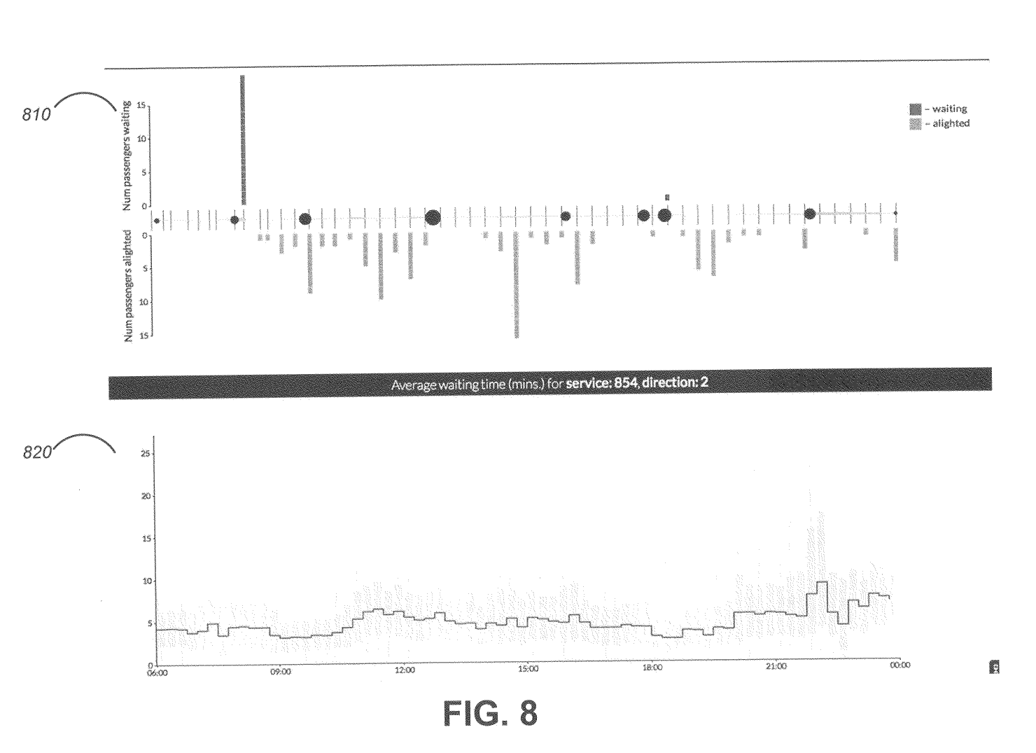

FIG. 8 illustrates charts 810 and 820 related to a certain bus line. For example, the chart 810 displays the numbers of passengers waiting and alighted at each station. The chart 820 displays average waiting times for this certain bus line during 6:00 AM-00:00 AM. The numbers of passengers waiting and alighted at each station are calculated and stored in the terse tables. The client device 170 pulls the unprocessed terse tables from the server side and processes the terse table locally to render the chart 810. In addition, the average waiting times for this certain bus line during 6:00 AM-00:00 AM can be presented in the chart 820 in a similar manner.

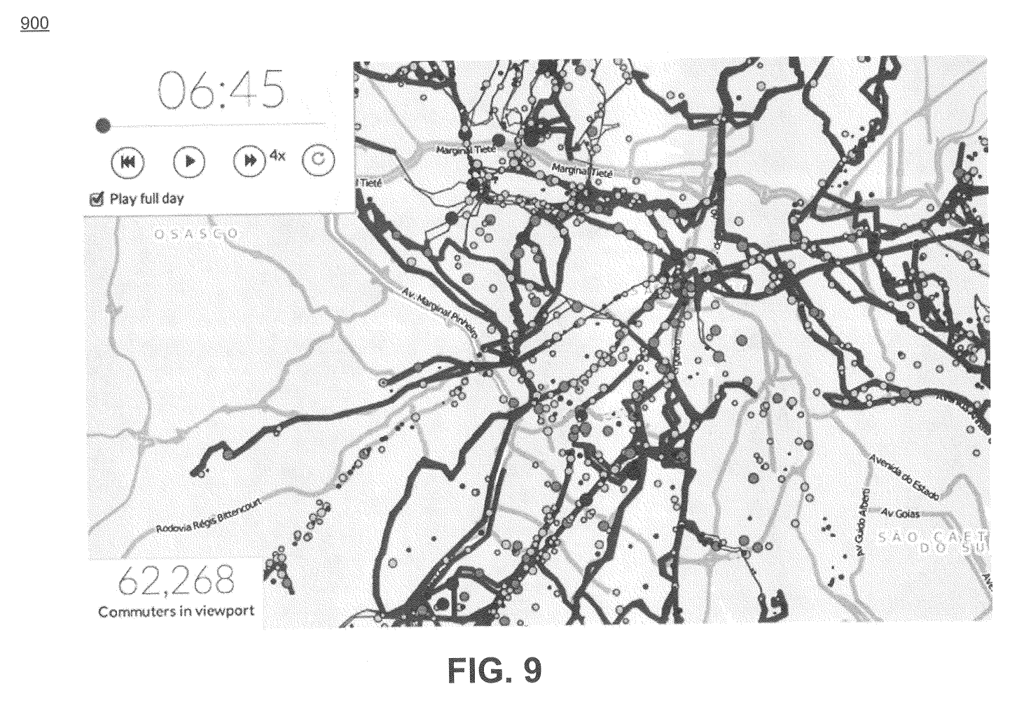

FIG. 9 illustrates a visualization 900 showing a view of a bus line system that includes multiple bus lines. Similar to the process described with reference to FIG. 5, data describing routes of bus lines, locations of buses and occupancy of each bus is extracted and saved in the terse tables in the database 130 by the record processing module 115. The client device 170 requests and receives the terse tables for rendering the visualization 900.

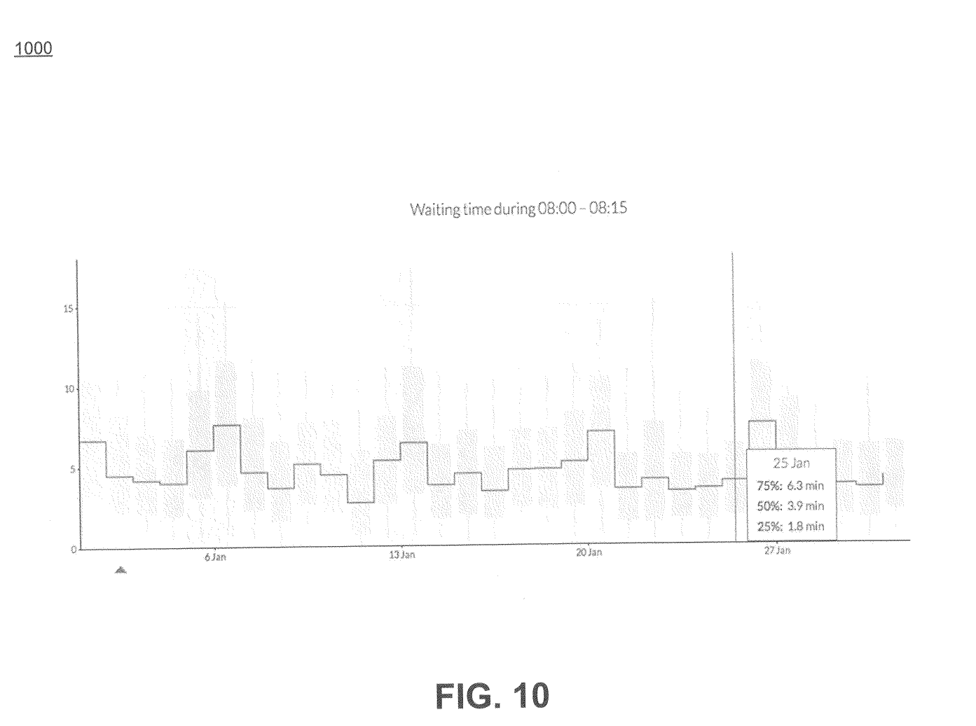

FIG. 10 illustrates a chart 1000 showing waiting times during 8:00 AM-8:15 AM for January. For example, the waiting times during 8:00 AM-8:15 AM are calculated and stored in the terse tables. The client device 170 pulls the unprocessed terse tables from the server side and processes the terse table locally to render the chart 1000.

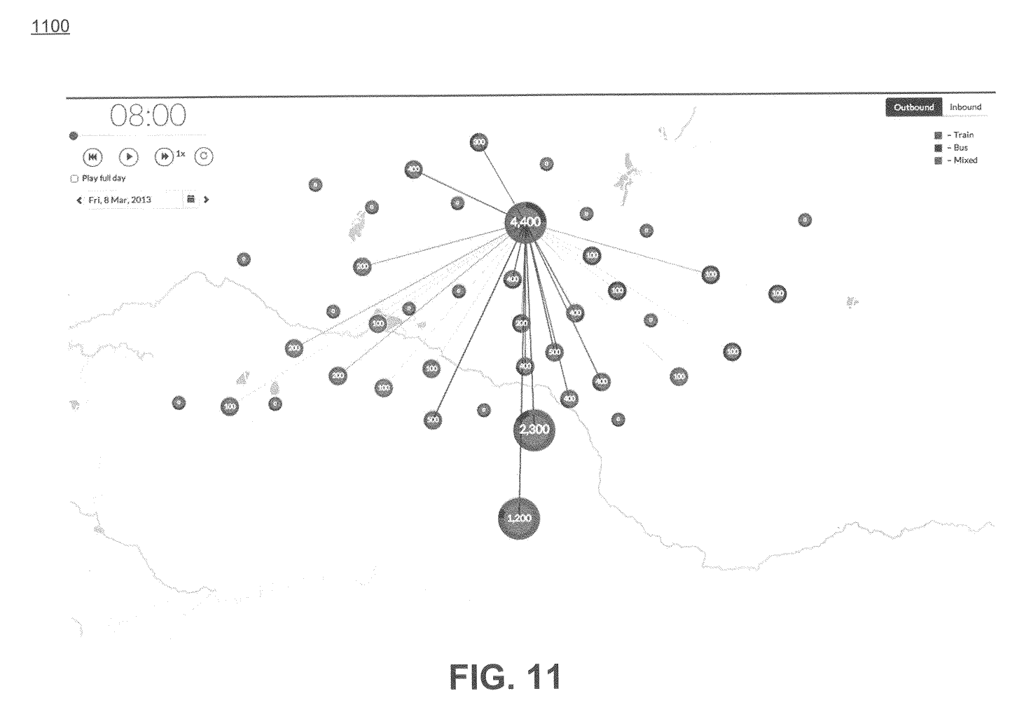

FIG. 11 illustrates a visualization 1100 showing outbound commuter flows on a map. In one embodiment, possible work locations and resident locations of passengers using the transportation system can be estimated based on the commuter flows. Statistics summarizing the experience of commuters can be obtained from the results of the reconstruction module 115 based on collected trip records and/or fleet data. The client device 170 requests and receives the reconstructed data for rendering the chart 1100.

### Additional Configuration Considerations

Accordingly, as described above, the system and method for fast rendering of visualizations provides numerous advantages over the traditional model. For example, the system and method allow a faster communication between the server 110 and the client device 170 and thus reduces communication latency. This is particularly helpful for interactive and real-time visualizations. In addition, the system and method enable huge reduction in size of data sent by the server 110, for example, in applications where processed data is highly dependent on certain common data. Further, local caching and processing makes the system also suitable for offline use. Moreover, the system and method enable fast and real-time interaction with huge datasets by using a simple data chunking logic and handling all the processing on the client device 170.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors, e.g., processor 202) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software (or program code) to perform certain operations. It will be appreciated that the decision to implement a hardware module mechanically, in dedicated and permanently configured circuitry, or in temporarily configured circuitry (e.g., configured by software or program code) may be driven by cost and time considerations.

The various operations of example methods described herein may be performed, at least partially, by one or more processors, e.g., processor 202, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors 202), these operations being accessible via a network (e.g., the Internet) and via one or more appropriate interfaces (e.g., application program interfaces (APIs).)

The performance of certain of the operations may be distributed among the one or more processors, e.g., processor 202, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for fast rendering of visualizations. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method comprising:
determining, using a processor, a set of data required for rendering a visualization on a client device based on a user input;
transmitting a request for the set of data to a server computer;
receiving one or more terse tables corresponding to the set of data;
generating the set of data by combining the received one or more terse tables; and
rendering a visualization on the client device based on the set of data.

2. The method of claim 1, wherein the set of data is a subset of required data for rendering the visualization on the client device.

3. The method of claim 2, wherein combining the received one or more terse tables comprising:
combining the one or more terse tables with one or more other terse tables that exist on the client device.

4. The method of claim 3, wherein combining the one or more terse tables with one or more other terse tables that exist on the client device is based on common data between the one or more terse tables and the one or more other terse tables that exist on the client device.

5. The method of claim 1, wherein the one or more terse tables include the set of data.

6. The method of claim 1 further comprising:
storing the one or more received terse tables; and
deleting outdated terse tables periodically.

7. The method of claim 1, wherein the set of data comprises at least one of a location, a name, an identifier, occupancy and a time.

8. The method of claim 1, wherein the set of data describes movements of a plurality of transportation vehicles.

9. The method of claim 8, wherein the visualization presents a graphical representation of a traffic condition associated with the plurality of transportation vehicles.

10. A computer-readable medium storing instructions that, when executed by a processor, cause the processor to:
determine a set of data required for rendering a visualization on a client device based on a user input;
transmit a request for the set of data to a server computer;
receive one or more terse tables corresponding to the set of data;
generate the set of data by combining the received one or more terse tables; and
render a visualization on the client device based on the set of data.

11. The computer-readable medium of claim 10, wherein the set of data is a subset of required data for rendering the visualization on the client device.

12. The computer-readable medium of claim 11, wherein combining the received one or more terse tables comprising:
combining the one or more terse tables with one or more other terse tables that exist on the client device.

13. The computer-readable medium of claim 12, wherein combining the one or more terse tables with one or more other terse tables that exist on the client device is based on common data between the one or more terse tables and the one or more other terse tables that exist on the client device.

14. The computer-readable medium of claim 10, wherein the one or more terse tables include the set of data.

15. The computer-readable medium of claim 10, further comprising:
storing the one or more received terse tables; and
deleting outdated terse tables periodically.

16. The computer-readable medium of claim 10, wherein the set of data comprises at least one of a location, a name, an identifier, occupancy and a time.

17. The computer-readable medium of claim 10, wherein the set of data describes movements of a plurality of transportation vehicles.

18. The computer-readable medium of claim 17, wherein the visualization presents a graphical representation of a traffic condition associated with the plurality of transportation vehicles.

19. A system comprising:
a memory storing instructions for a visualization module; and
a processor configured to execute the instructions to:
determine, using a processor, a set of data required for rendering a visualization on a client device based on a user input;
transmit a request for the set of data to a server computer;
receive one or more terse tables corresponding to the set of data;
generate the set of data by combining the received one or more terse tables; and
render a visualization on the client device based on the set of data.

20. The system of claim 19, wherein the visualization presents a graphical representation of a traffic condition associated with the plurality of transportation vehicles.
